(19) United States
(12) Patent Application Publication
(10) Pub. No.: US 2016/0152113 A1
(43) Pub. Date: Jun. 2, 2016

(54) DOOR STRUCTURE FOR AIR CONDITIONER OF VEHICLE

(71) Applicants: HYUNDAI MOTOR COMPANY, Seoul (KR); Halla Visteon Climate Control Corp., Daejeon (KR)

(72) Inventors: Yong Chul KIM, Hwaseong-si (KR); Su Yeon KANG, Seoul (KR); Jae Won HEO, Suwon-si (KR); Sung Hae PARK, Busan (KR); Jae Sik CHOI, Suwon-si (KR); Hak Kyu KIM, Daejeon (KR); Jung Jae LEE, Daejeon (KR); Sang Ki LEE, Daejeon (KR)

(73) Assignees: HALLA VISTEON CLIMATE CONTROL CORP., Daejeon (KR); HYUNDAI MOTOR COMPANY, Seoul (KR)

(21) Appl. No.: 14/680,952

(22) Filed: Apr. 7, 2015

(30) Foreign Application Priority Data
Nov. 27, 2014 (KR) 10-2014-0167382

(51) Int. Cl. B60H 1/00; B60H 1/26; B60H 1/24

(52) U.S. Cl. CPC B60H 1/00564; B60H 1/247; B60H 1/26

(57) ABSTRACT

A door structure for an air conditioner of a vehicle includes an indoor/outdoor air door having a dome shape. An outdoor air door has a plate shape and adjusts the amount of outdoor air introduced into the vehicle. First and second counter-flow preventing ribs are disposed vertically between the dome shaped indoor/outdoor air door and the plate shaped outdoor air door. The first counter-flow preventing rib is mounted to a first hinge which is connected to one end of the plate shaped outdoor air door. The second counter-flow preventing rib is mounted to be close to another end of the plate shaped outdoor air door. An air conditioning filter is disposed below the dome shaped indoor/outdoor air door, the plate shaped outdoor air door, and the first and second counter-flow preventing ribs and filters the introduced indoor air or outdoor air.

### CROSS REFERENCE TO RELATED APPLICATION

The present application claims the benefit of priority to Korean Patent Application No. 10-2014-0167382, filed on Nov. 27, 2014, the entire contents of which is incorporated herein for all purposes by this reference.

### TECHNICAL FIELD

The present disclosure relates to a door structure for an air conditioner of a vehicle, and more particularly, to a door structure for an air conditioner of a vehicle capable of independently controlling indoor air and outdoor air supplied into the vehicle and preventing outdoor air counter-flow when driving the vehicle at a high speed.

### BACKGROUND

A vehicle is provided with an air conditioner for cooling of an interior of the vehicle to provide a pleasant environment to passengers. However, an indoor air introduction amount to an air conditioning system of the vehicle increases depending on an intake door structure, a vehicle speed, and a wind amount in order to decrease ventilation loss, thus decreasing fuel efficiency and fuel consumption of the vehicle.

Referring to FIG. 1, outdoor air supplied into a vehicle according to the related art is introduced into the vehicle through an outdoor air inlet 11, and indoor air is introduced into the vehicle through an indoor air inlet 12.

Here, as a speed of the vehicle increases while the indoor air is being introduced, the outdoor air is introduced into an interior of the vehicle, thus deteriorating pleasantness of a passenger seated on a passenger's seat. For example, since it is cold during the winter and it is hot during the summer due to the introduced outdoor air, heating should be further made by a heater during the winter, and cooling should be further made by an air conditioner during the summer, energy loss is inevitable.

In addition, since an indoor air introduction rate increases when introduced indoor air increases in order to offset the introduction of the outdoor air, carbon dioxide (CO₂) in the interior of the vehicle increases, which makes the passenger uncomfortable.

Further, since the indoor air introduction rate increases when the introduced indoor air increases in order to offset the introduction of the outdoor air, an excessive amount of moisture is generated on a window of the vehicle to make a visual field of a driver obscure.

Referring to FIG. 2, when foreign materials such as leaves and the like are piled up outside the vehicle of an air conditioning filter 13 and the air conditioning filter 13 is replaced, the piled foreign materials such as the leaves are introduced into the vehicle by an electric motor 17 and a blowing fan 16.

FIG. 3 shows conditions in which the indoor air and the outdoor air are introduced into the interior of the vehicle to solve the above-mentioned problems. That is, the respective conditions into a case A in which indoor air of 0% and outdoor air of 100% are introduced, a case B in which indoor air of 100% and outdoor air of 30% are introduced, a case C in which indoor air of 100% and outdoor air of 22% are introduced, a case D in which indoor air of 100% and outdoor air of 15% are introduced, a case E in which indoor air of 100% and outdoor air of 7.5% are introduced, and a case F in which indoor air of 100% and outdoor air of 0% are introduced.

Here, an outdoor air variable 1 means a first step in which the outdoor air is introduced, an outdoor air variable 2 means a second step in which the outdoor air is introduced, and an outdoor air variable 3 means a third step in which the outdoor air is introduced.

Based on the above-mentioned contents, a gap (which allows the foreign materials not to be introduced into the blowing fan at the time of replacing the air conditioning filter) is present between a shaft supporting an outdoor air door and an upper end of the air conditioning filter in a smart intake structure including an indoor/outdoor air door and the outdoor air door depending on an air conditioner according to the related art. A counter-flow of the outdoor air into the interior is generated at the time of driving the vehicle at a high speed under a condition in which some of the outdoor air is introduced due to the gap.

A door structure of the blower unit has been developed to improve heating performance by simply assembling an auxiliary door to an indoor and outdoor air switching door in a snap scheme to allow some of indoor air to be introduced in an outdoor air introduction mode and improve an assembling property and productivity by decreasing the total number of assembled components. For this, the door structure includes an indoor/outdoor air switching door selectively opening and closing an indoor air inlet and an outdoor air inlet by a hinge shaft and having a flat panel shape and an auxiliary door opening and closing an auxiliary passage formed in the indoor/outdoor air switching door, which are disposed in the blower unit for the air conditioning system of the car. The auxiliary door includes an auxiliary door member, an auxiliary hinge shaft protruding to both sides to hinge around an upper end of the auxiliary door member, and catching pieces protruding downwardly at both ends of the hinge shaft. The indoor/outdoor air switching door has support parts protruding on a door member thereof. The support parts support both end portions of the auxiliary hinge shaft in a state in which they accommodate both end portions of the auxiliary hinge shaft therein, respectively, thereby allowing the auxiliary door to hinge within a predetermined hinging angle range.

However, there is a need to increase an outdoor air suction area in a state in which indoor air and outdoor air are introduced in a mixed ratio to decrease a fog generation rate under the same condition, decrease a concentration of carbon dioxide (CO₂) in the interior of the vehicle under the same condition, and install an outdoor air counter-flow preventing rib at a position of the gap.

### SUMMARY

An aspect of the present inventive concept provides a door structure for an air conditioner of a vehicle capable of independently controlling indoor air and outdoor air supplied into the vehicle and suppressing an outdoor air counter-flow phenomenon when driving the vehicle at a high speed.

According to an exemplary embodiment of the present inventive concept, a door structure for an air conditioner of a vehicle, which adjusts an amount of introduced outdoor air or an amount of introduced indoor air by a door, includes an indoor/outdoor air door having a dome shape and adjusting an amount of indoor air introduced into the vehicle and an amount of outdoor air introduced into the vehicle. An outdoor air door has a plate shape and adjusts the amount of outdoor air introduced into the vehicle. First and second counter-flow preventing ribs are disposed vertically between the dome shaped indoor/outdoor air door and the plate shaped outdoor air door. The first counter-flow preventing rib is mounted to a first hinge which is connected to one end of the plate shaped outdoor air door, and the second counter-flow preventing rib is mounted to be close to another end of the plate shaped outdoor air door. An air conditioning filter is disposed below the dome shaped indoor/outdoor air door, the plate shaped outdoor air door, and the first and second counter-flow preventing ribs and filters the introduced indoor air or outdoor air.

When the vehicle is driven at a high speed of a reference value or more in a state in which the dome shaped indoor/outdoor air door is opened by 100% and the plate shaped outdoor air door is partially opened such that the vehicle arrives at an outdoor air counter-flow condition, the plate shaped outdoor air door is fully open.

The air conditioning filter may include a filter cover disposed to be spaced apart from the second counter-flow preventing rib by a predetermined interval.

The door structure may further include a case having a concaved portion at a right side of the air conditioning filter, such that the right side of the air conditioning filter is partially inserted into the case by a predetermined width.

The air conditioning filter may include a filter insertion guide supporting an inserted portion of a lower end thereof and a filter assembling guide supporting another end thereof. The air conditioning filter may include a filter cover mounted to the filter insertion guide and the filter assembling guide to cover the air conditioning filter.

The amount of indoor air and the amount of outdoor air may be introduced into the vehicle at a mixed ratio of 65:35.

### BRIEF DESCRIPTION OF THE DRAWINGS

FIGS. 1 and 2 are views illustrating a door structure of an air conditioner of a vehicle according to the related art.

FIG. 3 is a view for illustrating a process of adjusting an indoor/outdoor air door and an outdoor air in an air conditioner according to the related art.

FIG. 4 is a view for comparing a door structure for an air conditioner of a vehicle according to an exemplary embodiment of the present inventive concept with that of the related art.

FIG. 5 is a view for comparing a door structure for an air conditioner for a vehicle according to another exemplary embodiment of the present inventive concept with that of the related art.

FIG. 6 is a view for describing a door structure for the air conditioner of a vehicle according to an exemplary embodiment of the present inventive concept in detail.

FIG. 7 is a view for comparing a control logic of the air conditioner of a vehicle according to an exemplary embodiment of the present inventive concept with that of the related art.

FIG. 8 is a view for comparing an air conditioning filter of the air conditioner for a vehicle according to an exemplary embodiment of the present inventive concept with that of the related art.

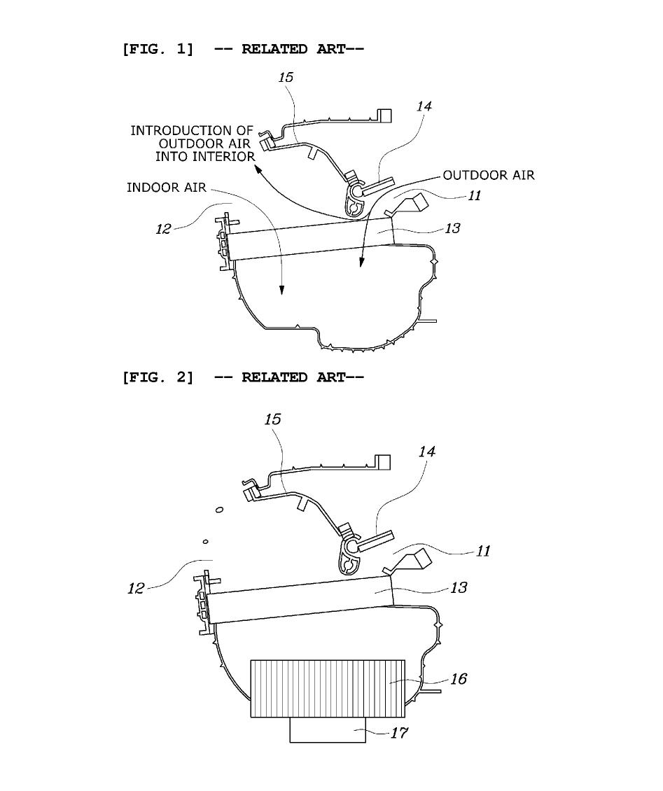

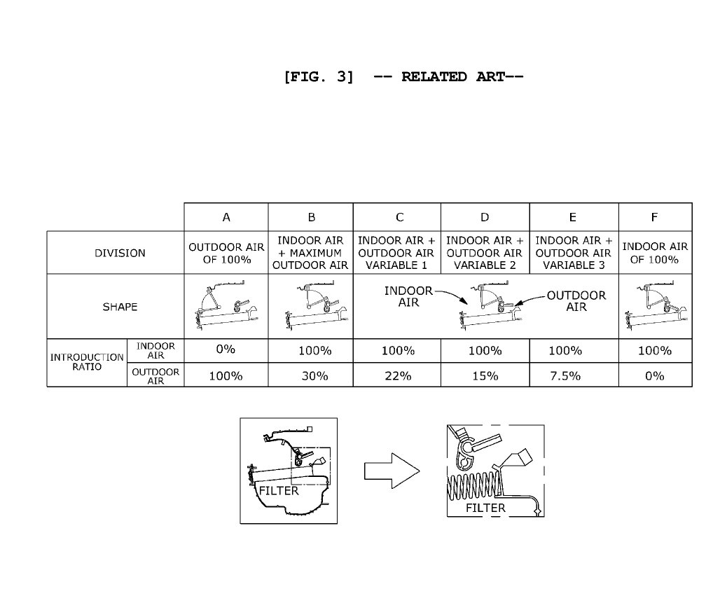

### DETAILED DESCRIPTION

Hereinafter, exemplary embodiments of the present inventive concept will be described in detail with reference to the accompanying drawings.

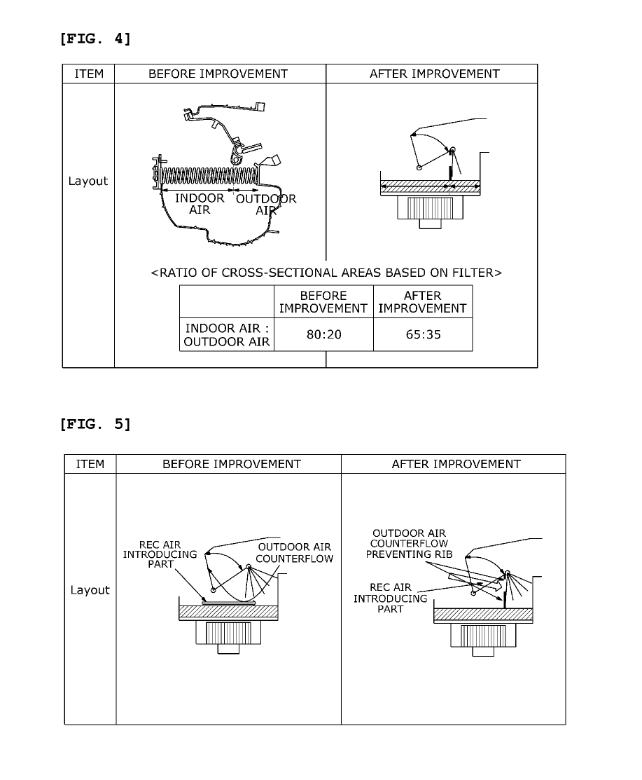

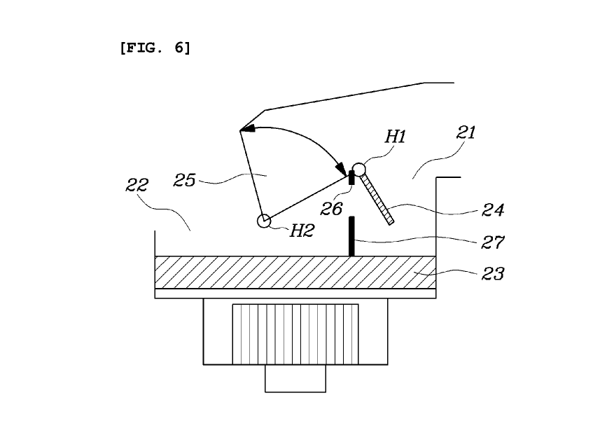

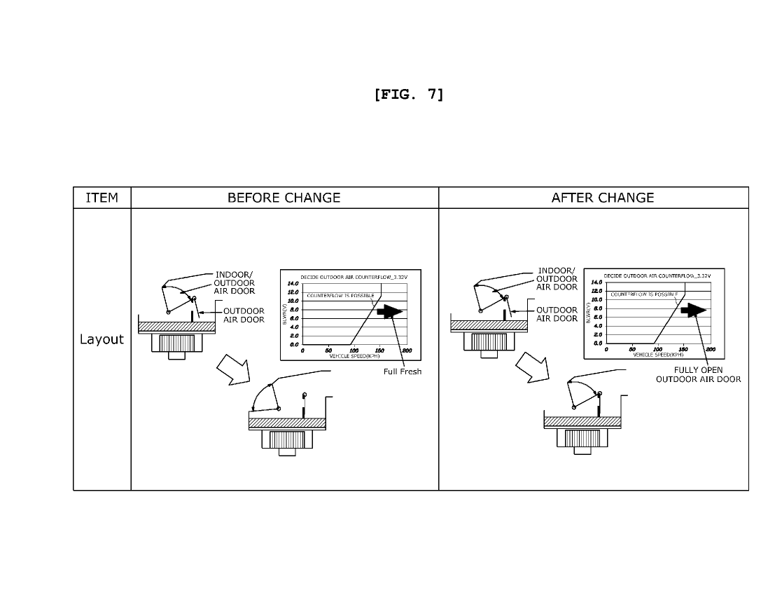

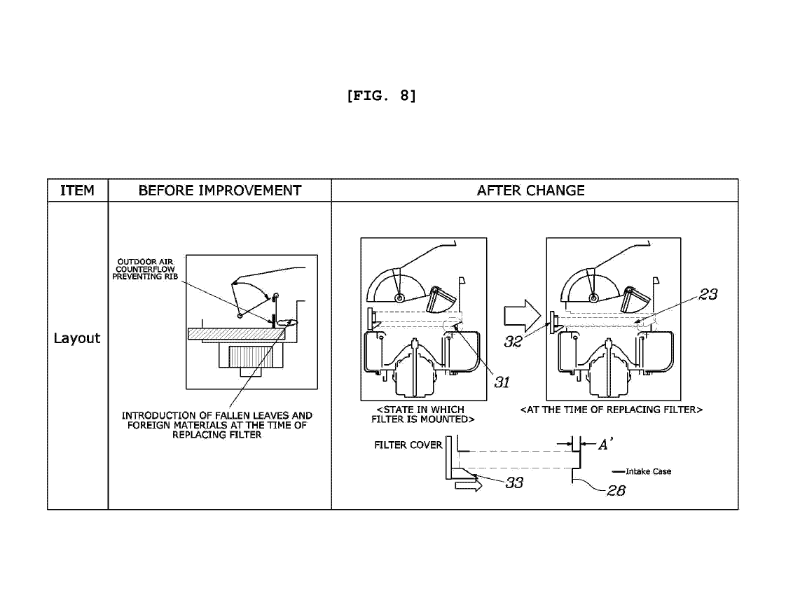

FIG. 4 is a view for comparing a door structure for an air conditioner of a vehicle according to an exemplary embodiment of the present inventive concept with that of the related art. FIG. 5 is a view for comparing a door structure for an air conditioner for a vehicle according to another exemplary embodiment of the present inventive concept with that of the related art. FIG. 6 is a view for describing a door structure for an air conditioner of a vehicle according to an exemplary embodiment of the present inventive concept. FIG. 7 is a view for describing a control logic of an air conditioner for a vehicle according to an exemplary embodiment of the present inventive concept. FIG. 8 is a view for describing an air conditioning filter of an air conditioner for a vehicle according to an exemplary embodiment of the present inventive concept.

An air conditioner for a vehicle according to an exemplary embodiment of the present inventive concept includes several components and is driven based on these components, however, an exemplary embodiment of the present inventive concept describes a structure and a control for indoor air and outdoor air of the air conditioner.

Although an air conditioner may be manually adjusted by a driver or a passenger seated on a passenger's seat, a model of an air conditioner automatically adjusted depending on temperature or humidity may be used optionally. Therefore, a structure and a control logic of an air conditioner to be described herein may be applied to both of manual and automatic air conditioners. An indoor/outdoor air door to be described has a dome shape of which an arc portion is a surface blocking introduced air, and an outdoor air door is formed in a plate shape of which a straight line portion is a surface blocking introduced air.

Referring to FIGS. 4 and 5, an outdoor air suction area is increased as compared to the related art so that a ratio of an indoor air suction area and an outdoor air suction area is changed from 80:20 to 65:35 based on an air conditioning filter in a state in which indoor air and outdoor air are introduced in a mixed ratio. Since the outdoor air suction area is increased, a volume of an outdoor air introducing part is increased as compared with the case in which the same pressure is applied to the outdoor air introducing part in the related art.

Referring to FIG. 6, an outdoor air inlet 21 allows a passage for outdoor air of a vehicle to flow into the vehicle and an indoor air inlet 22 for indoor air of the vehicle to enter so that air is recirculated in the vehicle. Here, the indoor air is introduced to the left and the outdoor air is introduced to the right. For example, in an actual product, the indoor air inlet and the outdoor air inlet may be positioned adjacently to the left or the right, and the left and the right may be changed with each other.

Lower ends of the outdoor air inlet 21 and the indoor air inlet 22 have an air conditioning filter 23 filtering foreign materials included in the introduced outdoor air or indoor air, a plate shaped outdoor air door 24 hinged around a first hinge H1 to adjust an amount of introduced outdoor air, and a dome shaped indoor/outdoor air door 25 hinged around a second hinge H2 to adjust the amount of introduced indoor and outdoor air, respectively.

A first counter-flow preventing rib 26 for blocking a counter-flow of the outdoor air introduced through the outdoor air inlet 21 and then flowing to the air conditioning filter 23 through the indoor air inlet 22 is fixed to the first hinge H1.

A second counter-flow preventing rib 27 for blocking a counter-flow of the outdoor air introduced through the outdoor air inlet 21 and then flowing to the air conditioning filter 23 through the indoor air inlet 22 is installed below the first hinge H1 in a vertical direction.

An outdoor air counter-flow has occurred at the time of driving the vehicle at a high speed in a state in which indoor air of 100% and some of the outdoor air are introduced may be fundamentally prevented by the first and second counter-flow preventing ribs 26 and 27 described above.

When an outdoor air counter-flow condition is generated, the control logic of the air conditioner apparatus needs to be designed so as to be different from that of the related art.

Referring to FIG. 7, when a counter-flow is generated at the time of driving the vehicle at a high speed, the control logic has been implemented so as to block introduction of the indoor air and introduce the outdoor air as much as possible by moving both of the indoor/outdoor air door 25 and the outdoor air door 24. In the present disclosure, a control is performed to completely open only the outdoor air door 24, thereby preventing a rapid temperature change in an interior of the vehicle to increase pleasantness and prevent an increase in air conditioning consumed power.

In addition, in the present disclosure, convenient facilities for preventing the foreign materials of an upper end of the air conditioning filter 23 outside the vehicle from being introduced around a blowing fan at the time of replacing the air conditioning filter 23 are added, which will be described with reference to FIG. 8.

The air conditioning filter 23 includes a filter cover 32 disposed so as to be spaced apart from the second counter-flow preventing rib 27 by a predetermined interval to prevent the foreign materials such as fallen leaves and the like piled up outside the vehicle from being introduced into the blowing fan or the like at the time of replacing the air conditioning filter 23.

A case 28 has a concaved portion at a right side of the air conditioning filter 23, such that the right side of the air conditioning filter 23 is inserted into the case 28 by a predetermined width A′.

Here, when the air conditioning filter 23 is inserted in the concaved portion having the predetermined width A′, introduction of fine dust from the outside into the interior of the vehicle is prevented, a lower end of the air conditioning filter 23 is supported to cover a gap with the second counter-flow preventing rib 27, thereby blocking the counter-flow of the outdoor air.

The air conditioning filter 23 includes a filter insertion guide 33 supporting an inserted portion of the lower end thereof and a filter assembling guide 31 supporting the remaining portions of the lower end thereof, and includes a filter cover 32 assembled with the filter insertion guide 33 and the filter assembling guide 31 to protect the air conditioning filter 23.

According to the present disclosure, since an outdoor air door suction area is increased, a volume of an outdoor air introducing part is increased as compared with the case in which the same pressure is applied to the outdoor air introducing part in the related art, such that a fog generation rate is decreased and a carbon dioxide increase speed is decreased.

According to the related art, when a speed of the vehicle increases and a voltage of the blowing fan arrives at a predetermined value, such that a counter-flow condition is generated, a control is performed to completely open (full fresh) the indoor/outdoor air door and the outdoor air door. However, in the present disclosure, a control is performed to maintain the indoor air of 100% and completely open (full fresh) the outdoor air door and an upper end portion of the air conditioning filter at which a counter-flow of the outdoor air is generated is closed to fundamentally prevent the counter-flow of the outdoor air, thereby decreasing a change amount of discharge temperature and consumed power of the air conditioner.

Further, a step is added to an assembling guide of the air conditioning filter to secure a gap at the time of assembling or disassembling, a distal end portion of the air conditioning filter is additionally inserted to support the air conditioning filter and block fine dust from being introduced into the interior through the gap, and a cover structure of the air conditioning filter is included to support a lower end portion of the air conditioning filter when mounting for replacing the air conditioning filter and to close the gap with the counter-flow preventing rib when mounting the cover of the air conditioning filter, thereby preventing the counter-flow of the outdoor air.

What is claimed is:

1. A door structure for an air conditioner of a vehicle, which adjusts an amount of introduced outdoor air or an amount of introduced indoor air, comprising:
an indoor/outdoor air door having a dome shape and adjusting the amount of indoor air introduced into the vehicle and the amount of outdoor air introduced into the vehicle;
an outdoor air door having a plate shape and adjusting the amount of outdoor air introduced into the vehicle;
first and second counter-flow preventing ribs disposed vertically between the dome shaped indoor/outdoor air door and the plate shaped outdoor air door, the first counter-flow preventing rib mounted to a first hinge which is connected to one end of the plate shaped outdoor air door and the second counter-flow preventing rib is mounted to be close to another end of the plate shaped outdoor air door; and
an air conditioning filter disposed below the dome shaped indoor/outdoor air door, the plate shaped outdoor air door, and the first and second counter-flow preventing ribs, the air conditioning filter filtering the introduced indoor air or outdoor air.

2. The door structure of claim 1, wherein when the vehicle runs at a high speed of a reference value or more in a state in which the dome shaped indoor/outdoor air door is fully opened and the plate shaped outdoor air door is partially opened such that the vehicle is in an outdoor air counter-flow condition, the plate shaped outdoor air door is fully open.

3. The door structure of claim 1, wherein the air conditioning filter includes a filter cover spaced apart from the second counter-flow preventing rib by a predetermined interval.

4. The door structure of claim 1, further comprising a case having a concaved portion at a right side of the air conditioning filter, such that the right side of the air conditioning filter is partially inserted into the case by a predetermined width.

5. The door structure of claim 1, wherein the air conditioning filter comprises:
a filter insertion guide supporting a lower end thereof and a filter assembling guide supporting another end thereof; and
a filter cover mounted to the filter insertion guide and the filter assembling guide and covering the air conditioning filter.

6. The door structure of claim 1, wherein the amount of indoor air and the amount of outdoor air are introduced into the vehicle at a mixed ratio of 65:35.

7. The door structure of claim 6, wherein the first counter-flow preventing rib is disposed to be offset by 15% from a middle point of the air conditioning filter.
